(19) United States
(12) Patent Application Publication
(10) Pub. No.: US 2010/0084512 A1
(43) Pub. Date: Apr. 8, 2010

(54) Luno Geo Wind Mill

(76) Inventor: Michael Pindrik, Baltimore, MD (US)

Correspondence Address: Michael Pindrik, 1802 Autumn Frost Lane, Baltimore, MD, 21209, US

(21) Appl. No.: 12/315,067

(22) Filed: Nov. 28, 2008

Related U.S. Application Data
(60) Provisional application No. 61/194,901, filed on Oct. 2, 2008.

(51) Int. Cl. B64G 1/00

(52) U.S. Cl. 244/158.2

(57) ABSTRACT

Super strong, super long tensile structures, connected to the anchor(s) on the Moon, ‘suspend’ in the Earth's atmosphere assemblies of wind energy catching devices (like turbines) positioned about 10-20 kilometers above the Earth's surface. The wind is actually an airflow generated by the Earth's rotation. The caught energy is converted to electricity and transmitted to Earth. A flat keel, attached to each assembly of turbines, stabilizes the assembly in the direction of the wind. The entire apparatus is stationary relative to the Moon and rotates around the Earth together with the Moon.

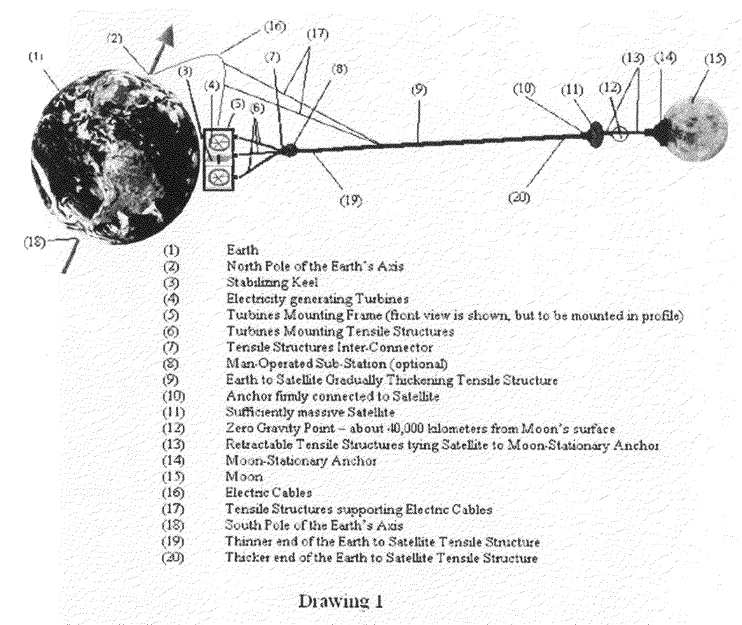

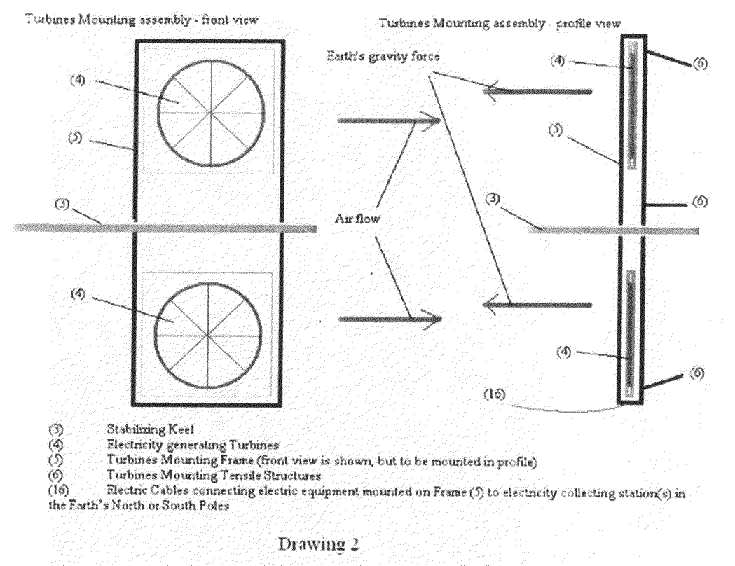

### REFERENCES CITED

### U.S. Patent Documents

Wind Mills:

| | | |
|---|---|---|
| 1,835,018 | December 1931 | Darrieus |
| D169290 | April 1953 | Sneed |
| 2,835,462 | May 1958 | Martin |
| 3,255,985 | June 1966 | Albertson, Jr. |
| 3,526,377 | September 1970 | Flatau |
| 3,997,136 | December 1976 | Finn et al. |
| 4,207,026 | June 1980 | Kushto |
| 4,366,939 | January 1983 | McMillan |
| 4,659,940 | April 1987 | Shepard |
| 4,942,506 | July 1990 | Flory |
| 5,269,647 | December 1993 | Moser |
| 5,645,248 | July 1997 | Campbell |
| 5,954,297 | September 1999 | Bukur |
| 6,072,245 | June 2000 | Ockels |
| 6,327,994 | December 2001 | Labrador |
| 6,375,424 | April 2002 | Scarpa |
| 6,425,552 | July 2002 | Lee et al. |
| 6,616,402 | September 2003 | Selsam |
| 6,781,254 | August 2004 | Roberts |
| 7,129,596 | October 2006 | Macedo |

Space Elevators:

| | | |
|---|---|---|
| 5,306,879 | April 1994 | Pearson |
| 6,035,974 | March 2000 | Richter et al. |
| 6,173,922 | January 2001 | Hoyt et al. |
| 6,260,807 | July 2001 | Hoyt et al. |
| 6,286,788 | September 2001 | Hoyt et al. |
| 6,290,186 | September 2001 | Hoyt et al. |
| 6,491,258 | December 2002 | Boyd et al. |

### FIELD OF THE INVENTION

The present disclosure relates partially to systems and methods for generating electricity with minimum pollution from the energy of the wind (in the presented disclosure the wind is the airflow caused by the Earth's rotation) and partially to systems and methods concerned with the construction of a Space Elevator (in the presented disclosure Space Elevator stretches to the Earth's moon).

### BACKGROUND AND PURPOSE OF THE INVENTION

The use of renewable energy resources continues to be an important factor in satisfying energy demands while substantially reducing environmental impacts. Many conventional renewable recourse energy generation technologies, however, have design limitations, fragility, low benefit-to-cost ratio or inadequate expansion capacity. Accordingly, there is a need for a new approach in wind turbines technologies that addresses some of these problems. The presented disclosure addresses such new approach in wind turbines technologies. As stated in Claims section, a few similar system configurations may exist that would provide the desired goal of generating electricity by harnessing the mechanical energy of the airflow caused by the Earth's rotation. Particularly, the said (in Claims section) satellite rotating around the Earth may be:
a) a man-built substantially massive space object rotating around the earth in an orbit similar to the orbits of currently existing satellites relatively close to the Earth; or
b) an asteroid ‘maneuvered’ to rotate around the earth in an orbit similar to the orbits of currently existing satellites relatively close to the Earth; or
c) a man-built substantially massive space object positioned less than 10,000 kilometers from the zero gravity point between the earth and the moon; or
d) an asteroid ‘maneuvered’ to the zero gravity region between the Earth and the Moon.
e) the Earth's Moon itself.

It is the opinion of the author that the alternatives c) or d) are more attractive than the alternative e) because during the construction and operation of the Luno Geo Wind Mill and Space Elevator system the spaceship's ‘docking’ to an object in the zero gravity region does not require most of the equipment dedicated to compensate for the gravity force of the Moon. It is the opinion of the author as well that the alternatives c) or d) are the more attractive than the alternatives a) and b) because the alternatives a) and b) have a higher risk of collision of a massive object (the said satellite) onto Earth with much shorter notice than the alternatives c) or d) would allow. Thus, all the statements and calculations in the presented disclosure are made in the relation to the alternatives c) and d), but said statements and calculations may be applied to other alternatives with minor changes.

As stated, the presented disclosure targets the possibility to harness the energy of the airflow caused by the Earth rotating around the Earth's axis. The energy is collected and transformed into electricity with the help of turbines (or other rotor devices) ‘suspended’ from a satellite (maybe Earth's Moon itself) in the Earth's air at about 10-20 kilometers above the Earth's surface. The airflow speed (relative to ‘stationary’ Moon) above the Earth's Equator may be calculated as the length of the Earth's equator (40,008 [km]) divided by 24 hours that is about 1,600 [km] (1,000 miles) per hour.

The presented disclosure utilizes the following facts about the Earth's Moon:
1. The Moon faces the Earth always with the same side allowing Moon-stationary devices (like an anchor) to face the Earth all the time.
2. North and South Poles of the Earth's Axis are the two points on Earth that remain stationary relative to the Moon during Earth's rotation around Earth's Axis.
3. On average, the Moon is at a distance of about 385,000 [km] from the center of the Earth. That is less than ten times of the length of the Earth's Equator.
4. The Moon has a nearly circular orbit (eccentricity e=0.05) and Moon's orbital period is 27.322 days. This is causing only about 1 kilometer variance of the distance of the Moon from the Earth during 27.322 days.
5. There is a Zero Gravity Region between the Moon and the Earth where the Earth's gravitational force is approximately equal to the Moon's gravitational force.
6. Since Moon's orbit Inclination is between 18 and 28 degrees relative to Earth's Equator, the Earth's atmosphere airflow speed at the location directly above the Earth under the Moon is between (1,600*cos(28 degrees))[km]/[hr] and (1,600*cos(18 degrees))[km]/[hr] that is about between 1,360 [km]/[hr] and 1,600 [km]/[hr].

The presented disclosure utilizes the following facts about Space Elevator proposals:
1. In Space Elevator discussions (see ‘Space Elevator’ From Wikipedia, the free encyclopedia) it is commonly accepted that the current technology is not capable of manufacturing materials that are sufficiently strong and light enough to build an Earth based Space Elevator, as the total mass of conventional materials needed to construct such a structure would be far too great.
2. Recent proposals for a Space Elevator are notable in their plans to use carbon nanotube-based materials as the tensile structure in the tether design, since the theoretical strength of carbon nanotubes appears great enough to make this practical.
3. Similar to the proposals for Space Elevator, carbon nanotube-based materials may provide the necessary strength-to-weight ratio to allow manufacture of a tensile structure (see (9) in the DRAWING 1) stretching from the Moon to Earth.

### BRIEF DESCRIPTION OF THE DRAWINGS

All objects in the presented drawings are shown for the illustration purpose. No considerations are given for the correct scale of distances and sizes.

DRAWING 1 is the drawing of a complete Luno Geo Wind Mill apparatus showing Electricity Collecting turbines (4) ‘suspended’ from the Moon (15) into the Earth's (1) atmosphere with the combination of:

Turbines Mounting Frame (5),

Tensile structures (6), (9) and (13)

SMTOS (11)—Sufficiently Massive Terrestrial Object-Satellite (optionally man-guided)

Moon-Stationary Anchor (14)

Stabilizing Keel (3), firmly mounted on the turbines Mounting Frame (5) perpendicular to the Earth's surface, provides stability for the turbines facing the direction of the wind (air flow generated by the Earth's rotation). The Stabilizing Keel operates in a similar way as a boat's keel.

Turbines (4) are mounted on the turbines Mounting Frame (5). The number of turbines on one turbines Mounting Frame (5) and the number of turbines Mounting Frames (5) are limited only by the strength of the tensile structure system (6), (9) and (13). As will be shown later in this disclosure, the number of turbines (4) has to be in thousands in order for Luno Geo Wind Mill to be economically justifiable. Turbine Mounting Tensile structures (6) need to be 3 [km] to 4.5 [km] long.

Tensile structure (9) is a ‘Gradually Thickening’ tensile structure with the diameter at the ‘bottom’ (near the Tensile structure Inter-Connector (7)) of about 6 [cm] (2.4 inches) and at the ‘top’ (near the SMTOS (11)) about 10 [cm] (or 4 inches).

(Optionally man-guided) Sufficiently Massive Terrestrial Object-Satellite (SMTOS) (11) is positioned in the vicinity of the Zero Gravity Region where Earth's gravitational force is approximately equal to the Moon's gravitational force.

Electric Cable (16) connects electric equipment mounted on turbines Mounting Frame (5) to the electricity transmitting station(s) positioned at the vicinity of the North Pole (2) or South Pole (18). North and South Poles of the Earth's Axis are the two points on Earth that remain stationary relative to the Moon during Earth's rotation around Earth's Axis. Support Tensile structures (17) maintain desired position of the Electric Cable (16) above the Earth's surface. The maximum length of Support Tensile structures (17) should be comparable to the Earth's diameter—about 12,738 [km]. Similar to the Tensile structure (9), these tensile structures will also have to be made from carbon nanotubes material.

DRAWING 2 is the drawing of a possible implementation of the Turbine Mounting assembly presenting the front and profile views of such assembly. This Drawing indicates the direction of the wind generated by the Earth's rotation and the direction of the Earth's gravity force.

### DETAILED DESCRIPTION Of THE INVENTION

As stated in the BACKGROUND section, the Moon faces the Earth always with the same side. This allows a Moon-Stationary Anchor (14) to be firmly grounded on the side of the Moon facing the Earth. The tensile structure system (13) and (9) connected to this Moon-Stationary Anchor, being pulled by the Earth's gravitational force, will always point to the Earth.

The distance of the Zero Gravity Region from the Moon may be calculate from the formula:

Earth-Mass*Earth-Distance²=Moon-Mass*Moon-Distance²

From this formula we can obtain:

Earth-Distance²/Moon-Distance²=Moon-Mass/Earth-Mass

Since Moon-Mass/Earth-Mass=1/81 (NASA Solar System Exploration), we have:

Earth-Distance²/Moon-Distance²=1/81

From this we can obtain:

Earth-Distance/Moon-Distance=1/9

The distance of the Zero Gravity Region from the Moon=1/(1+9)*385,000=38,500 [km]

The distance of the Zero Gravity Region from the Earth=385,000−38,500=346,500 [km].

As stated in the BACKGROUND section, the Moon has a nearly circular orbit (eccentricity e=0.05). Based on this value of eccentricity (e=0.05), the formula defining the eccentricity [Semimajor_axis²−Semimanor_axis²=Semimajor_axis²*e²] and the fact that on average, the Moon is at a distance of about 385,000 [km] from the center of the Earth, it is possible to calculate that the difference between the maximum distance of the Moon from the Earth and the minimum distance of the Moon from the Earth is less than 1,000 kilometers. Since the length of the Retractable Tensile structure (13) is proposed to be about 38,500 kilometers, it is feasible to have (13) to be retracted or released by 1,000 kilometers periodically during the Moon's orbital period of 27.322 days. This will make the distance of turbines (4) from the Earth to be permanent or with slight variations in the range of 10-20 kilometers. The variation in length will put some extra load on the Retractable Tensile structure (13), but this extra load will be insignificant. During the retraction or release of the Retractable Tensile structure the speed of the SMTOS relative to the Moon will be 1000/27.3=36.6 [km] per day or 36.6/24=1.5 [km] per hour.

Tensile structure (9) in DRAWING 1, stretching from the Moon to Earth is about 346,500 kilometers long. The usage of the carbon nanotube material together with proposed here Gradually Thickening (towards the Moon) Tensile structure (9) make it theoretically (and in the future practically) possible to have Tensile structure (9) to be sufficiently strong to support it's own weight together with the anticipated weight of turbines.

Assuming that the weight of one Luno Geo Wind Mill Turbine (4) is 3 tons (for comparison, dry weight of a Rolls-Royce Trent 900 is 6.3 tons—see http://en.wikipedia.org/wiki/Rolls_Royce_Trent), 5,000 turbines will have the weight of about 15,000 tons. As stated in the BACKGROUND section for Space Elevator, carbon nanotube material may provide the necessary strength to weight ratio. It is more or less clear (even without calculations, but will be supported by calculations later on in this disclosure) that simple uniformly thick tensile structure will not be able to hold it's own weight of the length from the Moon to the Earth even if decreased gravitational force is taken into the account. For this reason a Gradually Thickening tensile structure is proposed—see full explanation and calculations in the section ‘Feasibility Of The Implementation’.

The task of manufacturing and installing a massive tensile structure system (9) in space is similar in many respects to the task of constructing a Space Elevator. In the Space Elevator discussions it is commonly accepted that the current technology is not capable of manufacturing materials that are sufficiently strong and light enough to build an Earth based Space Elevator as the total mass of conventional materials needed to construct such a structure would be far too great. Recent proposals for a Space Elevator are notable in their plans to use carbon nanotube-based materials as the tensile structure in the tether design, since the theoretical strength of carbon nanotubes appears great enough to make this practical (see ‘Space Elevator’ From Wikipedia, the free encyclopedia).

Delivery of the massive Tensile structure (9) to the Moon's vicinity is also a challenge that may not be possible currently. The potential solution suggested here relies on realization of a Space Elevator. If built, Space Elevator supposed to provide cheap enough method of delivering into space large quantities of material (see ‘Space Elevator’ From Wikipedia, the free encyclopedia).

While relying (during the construction of Luno Geo Wind Mill) on the existence of a Space Elevator for delivering a massive tensile structure system (9) to space, Luno Geo Wind Mill itself (after being built) may be used as a Space Elevator stretching all the way to the Moon. The Man Operated Sub-Station (element 8 in the DRAWING 1 therein) is proposed to be positioned just above Tensile structures Interconnect (7). This means the Man Operated Sub-Station will be in the range of 12 to 22 kilometers above the Earth's surface. A jet airplane, flying at the speed of between 1,360 and 1,600 kilometers per hour, in parallel to (and ‘synchronously’ with) the Man Operated Sub-Station, may deliver a space capsule to the Man Operated Sub-Station. The weight (mass) of a space capsule may be quite large and still will be insignificant compared to the total mass of the tensile structure system together with the turbines' assembly, thus presenting no significant extra load on the parts of Luno Geo Wind Mill apparatus.

(Optionally man-guided) Sufficiently Massive Terrestrial Object-Satellite (SMTOS) is proposed to be positioned in the vicinity of the Zero Gravity Region (12)—about 38,500 kilometers from the Moon's surface. SMTOS may be constructed incrementally by delivering large quantities of material from the Earth using Space Elevator(s). Alternatively, a medium size asteroid may be used as SMTOS if this asteroid is captured and maneuvered into the correct location in the Zero Gravity Region. The purpose of SMTOS is to reduce the force on the Retractable Tensile structure (13) and the Moon-Stationary Anchor (14). In fact, this tension is virtually zero if SMTOS is positioned properly relative to the Zero Gravity point. If SMTOS is positioned closer to the Earth than the Zero Gravity Region (12) and/or combined mass of (3), (4), (5), (6), (7), (8), (9), (10) is significant relative to the mass of SMTOS, the Earth's gravitational force becomes greater than the Moon's gravitational force so the tensile structure (13) prevents the SMTOS (together with attached to it tensile structure system) from ‘falling’ onto the Earth. If SMTOS is positioned closer to the Moon than the Zero Gravity Region (12), the Moon's gravitational force on SMTOS becomes greater than the Earth's gravitational force on SMTOS and this difference in forces offsets the Earth's gravitational force. This allows additional turbines (4) to be attached to the tensile structure system (6) and (9) without significant increase of load on the Retractable Tensile structure (13) and on Anchor (14). SMTOS's mass has to be at least 81 time greater than the total mass of tensile structures and Turbine Mounting assemblies (81 is the ratio of Earth's and Moon's masses).

The combination of the Earth's gravity force and the pulling strength of the tensile structures system (6) and (9) prevent the Turbine Mounting assembly from moving upwards or downwards relative to the Earth's surface. These forces also prevent the Turbine Mounting assembly from moving substantially in the direction of the wind, although some oscillation (‘swinging’) is feasible and can be minimized with proper selection of the distance of the Turbine Mounting Frames (5) from the Earth's surface where the density of the air is lower and the wind force is lighter.

Turbine Mounting Tensile structures (6) need to be long enough to reach the farthest Turbine. Since the number of turbines is estimated at about 5,000, each turbines Frame may house two turbines and the distance between Turbine Frames should be about 100 m, the total area for turbines may be calculated as: (5,000/2)*0.01 [km]̂2=25 [km]̂2. To calculate the radius of the circular area we need to resolve: [Pi]*R̂2=25 [km]̂2. Resolving this equation, we obtain R as about 2.8 [km].

Economical Justification

Since the construction of Luno Geo Wind Mill apparatus will be a massive-scale project, it is prudent to estimate the potential cost and cost-effectiveness of such project. To do that the following symbols will be used:

T—the ‘desired’ number of turbines (4) in Luno Geo Wind Mill apparatus

C—the cost of manufacturing and installing one Turbine (4)

S—the cost of manufacturing and delivering the tensile structure system

We can say that the Luno Geo Wind Mill apparatus cost is: T*C+S.

In order to estimate the amount of electrical power we can expect from a single Luno Geo Wind Mill Turbine (4), we may assume (more or less realistically) that the power of wind energy harnessed by a turbine will be comparable to the power generated by a large jet engine. We can take 90,000 horsepower as such an estimate (see http://education.rolls-royce.com/jet-engines-for-Boeing-777/). Since one horsepower equals about 0.75 kilowatt (see http://en.wikipedia.org/wiki/Horsepower#Mechanical_horsepower), the engine's max power in megawatts is 90*0.75=67.5 megawatts. Assuming 30% efficiency of the Luno Geo Wind Mill Turbine (4) (comparable to efficiency of conventional windmills), we can expect 21 MW (megawatts) of electrical power from one turbine. (For comparison, largest existing windmill turbine is currently generating about 7 MW of power.)

Thus, the cost per megawatt is: (T*C+S)/(21*T)

The cost of 1 megawatt for windmills is about $1.5 million (see http://www.jcmiras.net/surge/p83.htm). In order to be price competitive with conventional windmills, Luno Geo Wind Mill cost per megawatt should be:

(T*C+S)/(21*T)<$1.5 M

Or

C/21+S/(21*T)<$1.5 M

Or

C+S/T<$31.5 M

Or:

S/T<$(31.5−C) M

For the purpose of understanding the meaning of this formula, let us further assume that the cost to build and install one Luno Geo Wind Mill Turbine (4) is $10 million. For comparison, the cost estimate for one Rolls-Royce Trent engine for Airbus A380 is about $20 million (see http://www.aerospace-technology.com/features/feature2019/), but Luno Geo Wind Mill Turbine (4) does not need any ‘jet’ aspect that is in Rolls-Royce Trent engine, so the cost will be substantially lower.

Thus:

S/T<$(31.5−10) M

Or:

S/T<$21.5 M

Or:

T>S/21.5

The cost of installation of tensile structures for Luno Geo Wind Mill (S) should probably be comparable to the NASA's announced budget for fiscal year 2009 ($17.6 billion—see http://www.nasa.gov/home/hqnews/2008/feb/HQ_{—}08034_FY2009_budget.html). More or less ‘safe’ estimate for S is $100 billion, thus giving us an estimate for T=5,000 turbines. 5,000 turbines with 21 megawatt each supposed to generate enough electricity for 25 million of American homes.

Feasibility of the Implementation

Following are calculations of feasibility to suspend the 15,000 tons system of turbines in the Earth's atmosphere based on deployment on the carbon nanotubes material that is predicted to have Breaking Length (also known as self support length) of 4716 [km] and density of 1.34 g/[cm]³ (see http://en.wikipedia.org/wiki/Specific_strength).

First we need to estimate the diameter of a cable that would hold 15,000 tons. Since cable with the diameter of 1 [cm]² can hold (at Earth's surface):

4716*1000*100 [cm]*1 [cm]²*1.34 g/[cm]³=631944 kilogram or about 632 tons.

In order to suspend 15,000 tons the cable thickness has to be:

15,000/632=˜24 [cm]².

From the equation Pi*R²=24 [cm]²

We can obtain R as \sqrt{(24/3.14)}=\sqrt{(7.6)}=2.8 [cm]˜3 [cm] (1.2 inches).

The diameter (and the thickness) of the cable needed to be 6 [cm] (2.4 inches).

As stated earlier, it is more or less clear that simple uniformly thick cable 384,000 [km] long will not be able to hold it's own weight not to mention the additional weight of 15,000 tons. For this reason a Gradually Thickening cable is proposed and supporting calculations follow.

To calculate the weight of the Gradually Thickening cable the following notations will be used:

E—Earth's radius [˜6357 km]

L—distance to the Zero Gravity Region [˜346,500 km]

K—ratio L/E

L=K*E

L−E=K*E−E=(K−1)*E

L=346500

E=6357

Thus K=L/E=54.5

[Rb]—radius of the Cable (9) at the ‘bottom’ (closer to the Earth, at distance E from Earth's center), that has to support the weight of turbines N=15,000 tons.

[Rt]—radius increment at the ‘top’ (at the distance L from Earth's center)—to be determined

[Rx]—radius of material at a distance X from Earth (E<=X<=L)

We will look for Rx in the form:

Rx=[Rb]+[Rt]*(X−E)/(L−E)

Rx=[Rb]+[Rt]*(X−E)/((K−1)*E)

Rx=[Rb]+[Rt]*X/((K−1)*E)−[Rt]*E/((K−1)*E)

Rx=[Rb]+([Rt]*X)/((K−1)* E)−[Rt]/(K−1)

Rx=([Rt]/((K−1)*E))*X+([Rb]−[Rt]/(K−1))

Or using symbols:

Q=([Rt]/((K−1)*E))

B=([Rb]−[Rt]/(K−1))

Rx=Q*X+B

To evaluate Rx we need to write the equation for the weight of the Cable (9).

Using:

D—density of carbon nanotube material

M—Earth's mass

Pi[=˜3.14]

Weight of slice dx at a distance X from the center of the Earth is:

(D*M*[Pi])*dx*(Qx+B)²/x²

To calculate cable weight we take the integral:

∫((D*M*[Pi])*(Q*X+B)²)/X²=(D*M*[Pi])*(−B²/X+2*Q*log(X)*B+Q²*X)

Or cable weight is:

W=(D*M*[Pi])*(−B²/X+2*Q*log(X)*B+Q²*X) [X from E to L]

So we need to calculate W=W(L)−W(E)

W(L)=(D*M*[Pi])*(−B²/L+2*Q*log(L)*B+Q²*L)

Or substituting K*E for L:

W(L)=(D*M*[Pi])*(−B²/(K*E)+2*Q*log(K*E)*B+Q²*(K*E))

W(E)=(D*M*[Pi])*(−B²/E+2*Q*log(E)*B+Q²*E)

So:

W(L)−W(E)=(D*M*[Pi])*(−B²/(K*E)+2*Q*log(K*E)*B+Q²*(K*E))−(D*M*[Pi])*(−B²/E+2*Q*log(E)*B+Q²*E)

or W(L)−W(E)=

(D*M*[Pi])(−B²/(K*E)−(−B²/E)+2Q*log(K*E)*B−2Q*log(E)*B+Q²*(K*E)−Q²*E)

or W(L)−W(E)=

D*M*[Pi](−B²/(K*E)+B²/E+2Q*log(K)*B+2Q*log(E)*B−2Q*log(E)*B+Q²*(K*E)−Q²*E)

or W(L)−W(E)=

D*M*[Pi]*(−B²/(K*E)+B²/E+2Q*log(K)*B+Q²*(K*E)−Q²*E)

We will use notation Wt for the total weight of the cable plus additional weight of turbines N (=15,000) tons.

Thus Wt=W(L)−W(E)+N

Wt has to be lower than the weight (at the Earth surface level) of the Breaking Length [=4716 km] with the thickness [Pi]*([Rb]+[Rt])² at the ‘top’ point (end closer to the Moon), that is:

Thus Wt<(D*M*(4716 km)*[Pi]*([Rb]+[Rt])²)/E²

Since 4716 km=(4716 km/6357 km)*E=0.74*E,

Wt<0.74*E*(D*M*[Pi]*([Rb]+[Rt])²)/E²

Wt<0.74*D*M*[Pi]*([Rb]+[Rt])²/E

So [Rt] has to be found to satisfy the equation:

N+W(L)−W(E)<0.74*D*M*[Pi]*([Rb]+[Rt])²/E

The weighs of turbine N (=15,000 tons) at the Earth's surface may be expressed as

N=0.74*E*D*[Pi]*[Rb]²*M/E²—this is from the definition of Rb

Or: N=0.74*D*[Pi]*[Rb]²*M/E

Or using what was found for W(L)−W(E) and N=0.74*D*[Pi]*[Rb]²*M/E, we can write N+W(L)−W(E) as:

0.74*D*[Pi]*[Rb]²*M/E+D*M*[Pi]*(−B²/(K*E)+B²/E+2Q*log(K)*B+Q²*(K*E)−Q²*E)<0.74*(D*M*[Pi])*([Rb]+[Rt])²/E

We can divide both sides by (D*M*[Pi]) and eliminating parensis to obtain:

0.74*[Rb]²/E−B²/(K*E)+B²/E+2Q*log(K)*B+Q²*(K*E)−Q²*E<0.74*([Rb]+[Rt])²/E

Or simplifying with:

[−B²/(K*E)+B²/E=B²/E−B²/K*E=B²*((K−1)/(K*E))]

[Q²(K*E)−Q²*E=Q²*E*(K−1)]

we get simplified equation:

0.74*[Rb]²/E+B²*((K−1)/(K*E))+2Q*log(K)*B+Q²*E*(K−1)<0.74*([Rb]+[Rt])²/E

After multiplying both sides by (E):

0.74*[Rb]²+E*B²*((K−1)/(K*E))+E*2Q*log(K)*B+Q²*E²*(K−1)<0.74*([Rb]+[Rt])²

Or 0.74*[Rb]²+B²*(K−1)/K+2Q*log(K)*B*E+Q²*E²*(K−1)<0.74*([Rb]+[Rt])²

Or after replacing Q and B by definitions:

Q=([Rt]/((K−1)*E))

B=([Rb]−[Rt]/(K−1))

0.74*[Rb]²+([Rb]−[Rt]/(K−1))²*(K−1)/K+2*([Rt]/((K−1)*E))*log(K)*([Rb]−[Rt]/(K−1))*E+([Rt]/((K−1)*E))²*E²*(K−1)<0.74*([Rb]+[Rt])²

Or using X instead of [Rt] for solving the equation:

0.74*[Rb]²+([Rb]−X/(K−1))²*(K−1)/K+2*(X/((K−1)*E))*log(K)*([Rb]−X/(K−1))*E+(X/((K−1)*E))²*E²*(K−1)<0.74*([Rb]+X)²

Now transforming different parts as follows:

$${( [ Rb ] - X / ( K - 1 ) )}^{2} * ( K - 1 ) / K = ( K - 1 ) / K * ( {[ Rb ]}^{2} - 2 X * [ Rb ] / ( K - 1 ) + {X}^{2} / {( K - 1 )}^{2} ) = ( K - 1 ) / K * ( {X}^{2} / {( K - 1 )}^{2} - 2 X * [ Rb ] / ( K - 1 ) + {[ Rb ]}^{2} ) = ( ( K - 1 ) / K ) * ( 1 / {( K - 1 )}^{2} ) * {X}^{2} - ( ( K - 1 ) / K ) * 2 * [ Rb ] / ( K - 1 ) * X + ( ( K - 1 ) / K ) * {[ Rb ]}^{2} = ( 1 / ( ( K - 1 ) * K ) ) * {X}^{2} - 2 [ Rb ] / K * X + ( ( K - 1 ) / K ) * {[ Rb ]}^{2} ( 2 * X / ( ( K - 1 ) * E ) ) * log ( K ) * ( [ Rb ] - X / ( K - 1 ) ) * E = 2 * X / ( K - 1 ) * log ( K ) * ( [ Rb ] - X / ( K - 1 ) ) = 2 * X / ( K - 1 ) * log ( K ) * [ Rb ] - 2 * X / ( K - 1 ) * log ( K ) * X / ( K - 1 ) = 2 * log ( K ) * [ Rb ] / ( K - 1 ) * X - 2 * log ( K ) / {( K - 1 )}^{2} * {X}^{2} = {( X / ( ( K - 1 ) * E ) )}^{2} * {E}^{2} * ( K - 1 ) =$$

1/(K−1)*X0.74*([Rb]+X)²=0.74*(X²+2[Rb]*X+[Rb]²)=0.74*X²+1.5[Rb]X+0.74*[Rb]²

And using the transformed expressions:

0.74*[Rb]²+(1/((K−1)*K))*X²−2[Rb]/K*X+((K−1)/K)*[Rb]²+2*log(K)*[Rb]/(K−1)*X−2*log(K)/(K−1l)²*X²+1/(K−1)*X<0.74*X²+1.5[Rb]X+0.74*[Rb]²

Or moving all to one side and writing each product separately:

0.74*X²+1.5[Rb]X+0.74*[Rb]²−0.74*[Rb]²−(1/((K−1)*K))*X²+2[Rb]/K*X−(K−1)/K*[Rb]²−((2*log(K)*[Rb])/(K−1))*X+2*log(K)/(K−1)²*X²−(1/(K−1))*X>0

Or collecting all coefficients of X̂2 and X:

0.74*X²−(1/((K−1)*K))*X²+2*log(K)/(K−1)²*X²+1.5[Rb]X+2[Rb]/K*X−((2*log(K)*[Rb])/(K−1))*X−(1/(K−1))*X+0.74*[Rb]²−0.74*[Rb]²−(K−1)/K*[Rb]²>0

Or re-arranging:

X²*(0.74−1/((K−1)*K))+(2*log(K)/(K−1)²)+X*(1.5[Rb]+2[Rb]/K−(2*log(K)*[Rb])/(K−1)−1/(K−1))−(K−1)/K*[Rb]²>0

For ultimate K=L/E=346500/6357=54.5 most of the coefficients become insignificant compared to fixed values:

(0.74−1/((K−1)*K))+(2*log(K)/(K−1)²) is about the same as 0.74

(1.5[Rb]+2[Rb]/K−(2*log(K)*[Rb])/(K−1)−1/(K−1)) is about the same as 1.5[Rb]

And we can write:

X²*0.74+1.5*[Rb]*X−(K−1)/K*[Rb]²>0

Or:

0.74*X²+1.5[Rb]*X−0.98[Rb]²>0

Or dividing by 0.74:

X²+2[Rb]*X−1.33*[Rb]²>0

Since the solution of the equation

Ax2+Bx+C=0

is: (−B±{square root over ((B²−4AC)))}/2A

our equation is satisfied for

$$\begin{matrix}X = ( - 2 [ Rb ] + \sqrt{( 4 * {[ Rb ]}^{2} + 4 * 1.33 * {[ Rb ]}^{2} )} / 2 ) \\ = - [ Rb ] + [ Rb ] * \sqrt{( 4 + 4 * 1.33 )} / 2 \\ = - [ Rb ] + [ Rb ] * \sqrt{( 4 + 5.3 )} / 2 \\ = - [ Rb ] + [ Rb ] * \sqrt{( 9.3 )} / 2 \\ = - [ Rb ] + [ Rb ] * 3.05 / 2 \\ = - [ Rb ] + [ Rb ] * 1.52 \\ = [ Rb ] * 0.52\end{matrix}$$

So: X>0.52*[Rb]

Since X is [Rt] and [Rt] is the increment of the [Rb] at the ‘top’, the Radius at the ‘top’ needs to be >1.52*[Rb].

This is somewhat surprising, but very ‘encouraging’ result—only 52% increase in thickness of the cable.

Since for 5,000 Turbines (4) [Rb] was estimated to be 3 [cm] (1.2 inches), so the diameter at the ‘lowest’ point would be 6 [cm] (2.4 inches), the diameter at the ‘top’ (near Zero Gravity Region) would be 1.52*6 [cm]˜9.1 [cm] (or 3.6 inches).

1. A method of generating electricity, in which the mechanical energy of the rotating earth's atmosphere (the wind) is collected by turbines, in which the said turbines are attached to one end of a tensile structure (see http://en.wikipedia.org/wiki/Tensile_structure) in which the second end of the said tensile structure is anchored at an earth's satellite rotating around the earth with the angular speed different from the angular speed of the rotation of the earth.

2. A method of generating electricity of the claim 1, in which the said earth's satellite rotates around the earth at the distance between 160 and 100,000 kilometers.

3. A method of generating electricity of the claim 1, in which the said earth's satellite rotates around the earth at the distance greater than 100,000 kilometers and the said tensile structure is thinner at the end closer to the earth and the said tensile structure is thicker at the end connected to the said earth's satellite.

4. A method of generating electricity of the claim 1, in which the said earth's satellite is the earth's moon.

5. A method of generating electricity of the claim 1, in which the said earth's satellite is positioned less than 10,000 kilometers from the zero gravity point between the earth and the moon.

6. A method of generating electricity of the claim 1, in which the said earth's satellite is positioned less than 10,000 kilometers from the zero gravity point between the earth and the moon, in which the said earth's satellite is attached to a moon-stationary anchor with a tensile structure.

7. A method of generating electricity of the claim 1, in which the said earth's satellite is positioned less than 10,000 kilometers from the zero gravity point between the earth and the moon, in which the said earth's satellite is attached to a moon-stationary anchor with a retractable tensile structure, in which the said retractable tensile structure provides desirable distance of the said electricity-generating turbines above the earth's surface.

8. A method of generating electricity of the claim 1, in which electricity is transmitted to electricity collecting station(s) located closer than 1,000 kilometers from the earth's north pole.

9. A system to generate electricity comprising of:
a. the rotating earth; and
b. the rotating earth's atmosphere; and
c. electricity-generating turbines suspended in the earth's atmosphere; and
d. earth's satellite rotating around the earth with the angular speed different from the angular speed of the rotation of the earth; and
e. an earth-to-satellite tensile structure attached to the said electricity-generating turbines at the end closer to the earth and the said tensile structure anchored at the said satellite at the other end; and
f. a satellite-stationary anchor assuring the position of the said tensile structure and the said turbines to be stationary relative to the satellite and preventing the tensile structure and said turbines from falling onto earth.

10. A system of the claim 9 further comprising of a keel or other device capable of stabilizing the orientation of the said turbines in the direction of the airflow.

11. A system of the claim 9 further comprising of electricity transmitting cable(s).

12. A system of the claim 9 further comprising of safety assuring elements capable of fragmenting the said satellite, the said turbines and the said earth-to-satellite tensile structure into smaller segments, said smaller segments reduced to such size as to eliminate potential hazardous effects during the impact with the earth.

13. A system of the claim 9, in which the moon is the said earth's satellite.

14. A system of the claim 9, in which the said earth's satellite is positioned less than 10,000 kilometers from the zero gravity point between the earth and the moon, further comprising of a tensile structure connecting the said earth's satellite to a moon-stationary anchor.

15. A system of the claim 9, in which the said earth's satellite is positioned less than 10,000 kilometers from the zero gravity point between the earth and the moon, further comprising of a retractable tensile structure connecting the said earth's satellite to a moon-stationary anchor, where the said retractable tensile structure provides desirable distance of the said electricity-generating turbines above the earth's surface.

16. A system capable of functioning as a Space Elevator (see Wikipedia, the free encyclopedia at http://en.wikipedia.org/wiki/Space_elevator) comprised of:
a. the rotating earth; and
b. an earth's satellite; and
c. a tensile structure anchored at the said satellite at one end and attached to a counterweight object suspended into the earth's atmosphere with the other end; and
d. a satellite-stationary anchor assuring the position of the said tensile structure and the said counterweight object to be stationary relative to the satellite and preventing the tensile structure and said counterweight object from falling onto earth.

17. A system of the claim 15 further comprising of safety assuring elements capable of fragmenting the satellite and the said tensile structure into smaller segments, said smaller segments reduced to such size as to eliminate potential hazardous effects during the impact with the earth.

18. A system of the claim 15, in which the earth's moon is the said earth's satellite.

19. A system of the claim 15, in which the said earth's satellite is positioned less than 10,000 kilometers from the zero gravity point between the earth and the moon, further comprising of a tensile structure connecting the said earth's satellite to a moon-stationary anchor.

20. The priority of the method of the claim 1, in which the said method is described in the Provisional Patent Application 61/194,901 with the filing date Oct. 2, 2008.
